(19) United States
(12) Patent Application Publication
(10) Pub. No.: US 2026/0244121 A1
(43) Pub. Date: Aug. 20, 2026

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventor: Ryota KANEKO, Kanagawa (JP)

(73) Assignee: FUJIFILM Business Innovation Corp., Tokyo (JP)

(21) Appl. No.: 19/298,169

(22) Filed: Aug. 12, 2025

(30) Foreign Application Priority Data
Feb. 20, 2025 (JP) 2025-026226

(51) Int. Cl. G03G 5/04; G03G 5/147; G03G 21/18

(52) U.S. Cl. CPC G03G 5/04; G03G 5/14704; G03G 21/1814

(57) ABSTRACT

An electrophotographic photoreceptor has an inorganic protective layer on a photosensitive layer, in which a layer in the photosensitive layer, that is in contact with the inorganic protective layer, contains a filler, a volume fraction of the filler in the layer in contact with the inorganic protective layer is 50% or more, and an arithmetic mean roughness of a surface of the inorganic protective layer is 0.01 μm or less.

### CROSS-REFERENCE TO RELATED APPLICATIONS

This application is based on and claims priority under 35 USC 119 from Japanese Patent Application No. 2025-026226 filed Feb. 20, 2025.

### BACKGROUND

### (i) Technical Field

The present invention relates an electrophotographic photoreceptor, a process cartridge, and an image forming apparatus.

### (ii) Related Art

JP2010-210863A discloses an electrophotographic photoreceptor including at least a photosensitive layer on a circumferential surface of a cylindrical conductive substrate, in which, with regard to an average surface roughness Rz of the photosensitive layer in an axial direction, an average surface roughness R2 at a center portion is larger than an average surface roughness R1 at both end portions.

JP2004-233881A discloses an image forming apparatus including at least a charging unit, an image exposing unit, a developing unit, a transferring unit, a fixing unit, a cleaning unit, and a photoreceptor, in which the photoreceptor has at least a photosensitive layer and a surface protective layer in which an inorganic filler is dispersed in a resin, the surface protective layer has a ten-point average roughness Rz of 0.3 to 2.0 μm, the cleaning unit includes a cleaning blade that cleans a surface of the photoreceptor, and the cleaning blade surface is coated with spherical silicone resin particles.

JP2023-144987A discloses an image forming apparatus including an electrophotographic photoreceptor that has a photosensitive layer and a surface protective layer in this order on a conductive support, a charging unit that charges a surface of the electrophotographic photoreceptor, an electrostatic charge image forming unit that forms an electrostatic charge image on the charged surface of the electrophotographic photoreceptor, a developing unit that accommodates an electrostatic charge image developer containing an electrostatic charge image developing toner and develops the electrostatic charge image formed on the surface of the electrophotographic photoreceptor as a toner image by the electrostatic charge image developer, a transferring unit that transfers the toner image formed on the surface of the electrophotographic photoreceptor to a surface of a recording medium, and a cleaning unit that has a cleaning blade coming into contact with the surface of the electrophotographic photoreceptor and cleaning the surface of the electrophotographic photoreceptor, in which a static friction coefficient μ of the surface protective layer in the electrophotographic photoreceptor is 0.3 or less, and a difference Δ in strain between a stationary state and an operating state of the cleaning blade is 100 μST or less.

### SUMMARY

Aspects of non-limiting embodiments of the present disclosure relate to an electrophotographic photoreceptor having an inorganic protective layer on a photosensitive layer, in which a layer in the photosensitive layer, that is in contact with the inorganic protective layer, contains a filler, where the electrophotographic photoreceptor having excellent mechanical strength and cleaning performance as compared with a case where a volume fraction of the filler in the layer in contact with the inorganic protective layer is less than 50% or a case where an arithmetic mean roughness of a surface of the inorganic protective layer is more than 0.01 μm.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects.

According to an aspect of the present disclosure, there is provided an electrophotographic photoreceptor having an inorganic protective layer on a photosensitive layer, in which a layer in the photosensitive layer, that is in contact with the inorganic protective layer, contains a filler, a volume fraction of the filler in the layer in contact with the inorganic protective layer is 50% or more, and an arithmetic mean roughness of a surface of the inorganic protective layer is 0.01 μm or less.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to the present exemplary embodiment;

FIG. 2 is a view schematically showing a configuration of an example of an image forming apparatus according to the present exemplary embodiment; and

FIG. 3 is a view schematically showing a configuration of another example of the image forming apparatus according to the present exemplary embodiment.

### DETAILED DESCRIPTION

The present exemplary embodiment will be described below. The following descriptions and examples merely illustrate the exemplary embodiments, and do not limit the scope of the exemplary embodiments.

In the present specification, a numerical range described using “to” represents a range including numerical values listed before and after “to” as the minimum value and the maximum value respectively.

Regarding the numerical ranges described in stages in the present specification, the upper limit or lower limit of a numerical range may be replaced with the upper limit or lower limit of another numerical range described in stages. In addition, in the present specification, the upper limit or lower limit of a numerical range may be replaced with values described in Examples.

In the present specification, the term “step” includes not only an independent step but a step that is not clearly distinguished from other steps as long as the intended purpose of the step is achieved.

In the present specification, each component may include a plurality of corresponding substances. In a case where the amount of each component in a composition is mentioned in the present specification, and there are two or more kinds of substances corresponding to each component in the composition, unless otherwise specified, the amount of each component means the total amount of two or more kinds of the substances present in the composition.

In the present specification, a main component denotes a major component. In the present specification, the main component denotes a component that occupies 30% by mass or more of the total mass of a mixture obtained by mixing a plurality of components.

### Electrophotographic Photoreceptor

The electrophotographic photoreceptor (hereinafter, also simply referred to as “photoreceptor”) according to the present exemplary embodiment includes an inorganic protective layer on a photosensitive layer, in which a layer in the photosensitive layer, that is in contact with the inorganic protective layer, contains a filler, a volume fraction of the filler in the layer in contact with the inorganic protective layer is 50% or more, and an arithmetic mean roughness of a surface of the inorganic protective layer is 0.01 μm or less.

The electrophotographic photoreceptor in the related art has insufficient mechanical strength.

In addition, cleaning performance of an electrophotographic photoreceptor simply containing a filler are not sufficient due to unevenness on the surface, and image defects occur due to surface attachments.

In the electrophotographic photoreceptor according to the present exemplary embodiment, since the volume fraction of the filler in the layer in contact with the inorganic protective layer is 50% or more and the arithmetic mean roughness of the surface of the inorganic protective layer is 0.01 μm or less, the mechanical strength is excellent, and the surface is smoothed, whereby the cleaning performance is also excellent.

Hereinafter, the photoreceptor according to the present exemplary embodiment will be described in detail.

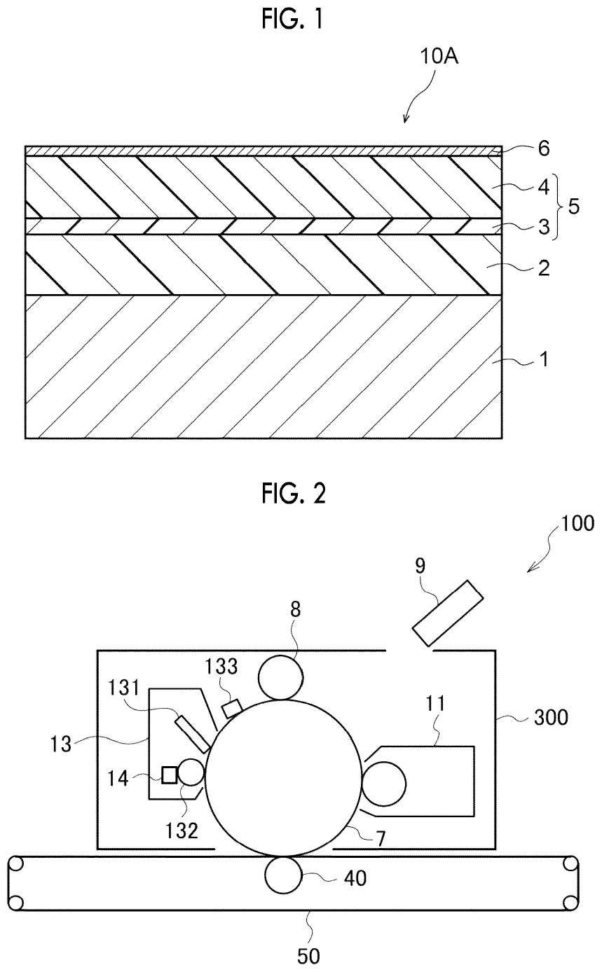

FIG. 1 is a partial cross-sectional view schematically showing an example of a layer configuration of the photoreceptor according to the present exemplary embodiment.

A photoreceptor 10A shown in FIG. 1 includes a lamination-type photosensitive layer.

The photoreceptor 10A has a structure in which an undercoat layer 2, a charge generation layer 3, a charge transport layer 4, and an inorganic protective layer 6 are laminated in this order on a conductive substrate 1, and the charge generation layer 3 and the charge transport layer 4 constitute a photosensitive layer 5 (so-called function separation-type photosensitive layer).

The photoreceptor 10A may include an interlayer (not shown) between the undercoat layer 2 and the charge generation layer 3. The undercoat layer 2 may or may not be provided.

Hereinafter, each layer of the photoreceptor will be described in detail. However, each layer of the photoreceptor will be described without a reference numeral.

### Inorganic Protective Layer

The electrophotographic photoreceptor according to the present exemplary embodiment has an inorganic protective layer on a photosensitive layer, in which an arithmetic mean roughness of a surface of the inorganic protective layer is 0.01 μm or less.

From the viewpoint of mechanical strength and cleaning performance, the arithmetic mean roughness of the surface of the inorganic protective layer is, for example, preferably 0.009 μm or less, more preferably 0.008 μm or less, and particularly preferably 0.005 μm or less. In addition, the lower limit value of the arithmetic mean roughness is not particularly limited, and may be, for example, a measurement limit value or 0.001 μm.

The arithmetic mean roughness Ra in the present disclosure is obtained by the measurement method described later.

A method of adjusting the above-described arithmetic mean roughness of the surface of the inorganic protective layer is not particularly limited; and examples thereof include a method of polishing the photosensitive layer to obtain a smooth surface, and then forming the inorganic protective layer thereon, a method of smoothing the surface by pressing a smooth surface of a heated Si wafer or the like against the surface of the inorganic protective layer, and a method of smoothing by applying a coating solution for forming the photosensitive layer in multiple layers, and then forming the inorganic protective layer thereon.

The inorganic protective layer is an inorganic material layer. Examples of the inorganic material include metal oxides such as gallium oxide, aluminum oxide, zinc oxide, titanium oxide, indium oxide, tin oxide, and boron oxide; metal nitrides such as gallium nitride, aluminum nitride, zinc nitride, titanium nitride, indium nitride, tin nitride, and boron nitride; carbon-based or silicon-based inorganic materials such as diamond-like carbon, amorphous carbon, hydrogenated amorphous carbon, hydrogenated and fluorinated amorphous carbon, amorphous silicon carbide, hydrogenated amorphous silicon carbide, amorphous silicon, and hydrogenated amorphous silicon; and mixed crystals thereof.

From the viewpoint of abrasion resistance and electrical properties of the photoreceptor, the inorganic protective layer is, for example, preferably a layer of an oxide of a Group 13 element, more preferably a layer consisting of a Group 13 element and an oxygen element, and still more preferably a layer consisting of at least one selected from the group consisting of gallium oxide and aluminum oxide. The inorganic protective layer may contain one metal oxide or two or more metal oxides.

From the viewpoint of maintaining an electrostatic latent image, a volume resistivity of the inorganic protective layer is, for example, preferably 1.0×10¹⁰ Ω·cm or more, and more preferably 1.0×10¹¹ Ω·cm or more.

A method of measuring the volume resistivity of the inorganic protective layer is as follows.

The inorganic protective layer is peeled off from the photoreceptor and used as a sample. The sample is sandwiched in a sample holder of an impedance analyzer (Toyo Corporation), the resistance value is measured at an AC voltage of 1 V and a frequency of 100 Hz, and the calculation is performed based on the area of an electrode and the thickness of the sample.

Examples of a method of forming the inorganic protective layer include known vapor phase film forming methods such as plasma chemical vapor deposition (CVD), organic metal vapor phase growth, molecular beam epitaxy, vapor deposition, and sputtering. For example, the inorganic protective layer can be formed by applying the plasma CVD film deposition device and film deposition conditions described in JP2014-191179A.

From the viewpoint of abrasion resistance and electrical properties of the photoreceptor, a layer thickness of the inorganic protective layer is, for example, preferably 0.2 μm or more and 10 μm or less, more preferably 0.4 μm or more and 8 μm or less, and still more preferably 0.6 μm or more and 6 μm or less.

### Photosensitive Layer

The electrophotographic photoreceptor according to the present exemplary embodiment has the inorganic protective layer on a photosensitive layer, in which a layer in the photosensitive layer, that is in contact with the inorganic protective layer, contains a filler, and a volume fraction of the filler in the layer in contact with the inorganic protective layer is 50% or more.

The photosensitive layer may be a lamination-type photosensitive layer or a single layer-type photosensitive layer.

In a case of the lamination-type photosensitive layer, the above-described layer in contact with the inorganic protective layer is a charge transport layer; and in a case of the single layer-type photosensitive layer, the above-described layer in contact with the inorganic protective layer is a single layer-type photosensitive layer.

The above-described filler may be inorganic particles or organic particles, but from the viewpoint of mechanical strength, for example, inorganic oxide particles are preferable.

Examples of the inorganic oxide particles include silica particles, alumina particles, and titanium oxide particles.

Among the above, from the viewpoint of mechanical strength, for example, silica particles are preferable as the filler.

Examples of the silica particles include dry silica particles and wet silica particles.

Examples of the dry silica particles include combustion silica (fumed silica) and explosion silica. The combustion silica is obtained by combustion of a silane compound. The explosion silica is obtained by explosively combusting metal silicon powder.

Examples of the wet silica particles include sedimentation silica particles, gel silica particles, colloidal silica particles (silica sol particles), and sol-gel silica particles.

The sedimentation silica particles and the gel silica particles are obtained by a neutralization reaction between sodium silicate and a mineral acid. A silica synthesized and aggregated under alkaline conditions is referred to as the sedimentation silica particles, and a silica synthesized and aggregated under acidic conditions is referred to as the gel silica particles.

The colloidal silica particles (silica sol particles) are obtained by polymerizing acidic silicate in an alkaline manner.

The sol-gel silica particles are obtained by hydrolysis of an organic silane compound (for example, alkoxysilane).

For example, the silica particles may have a surface subjected to a surface treatment with a hydrophobic agent.

In this manner, the number of silanol groups on the surface of the silica particles is reduced, and the occurrence of the residual potential is easily suppressed.

Examples of the hydrophobic agent include known silane compounds such as chlorosilane, alkoxysilane, and silazane.

Among the above, from the viewpoint of easily suppressing the generation of the residual potential, for example, a silane compound having a trimethylsilyl group, a decylsilyl group, or a phenylsilyl group is desirable as the hydrophobic agent. That is, the surface of the silica particles may have, for example, a trimethylsilyl group, a decylsilyl group, or a phenylsilyl group.

Examples of the silane compound having a trimethylsilyl group include trimethylchlorosilane, trimethylmethoxysilane, and 1,1,1,3,3,3-hexamethyldisilazane.

Examples of the silane compound having a decylsilyl group include decyltrichlorosilane, decyldimethylchlorosilane, and decyltrimethoxysilane.

Examples of the silane compound having a phenyl group include triphenylmethoxysilane and triphenylchlorosilane.

From the viewpoint of mechanical strength and cleaning performance, the volume fraction of the filler in the above-described layer in contact with the inorganic protective layer is, for example, preferably 55% or more, more preferably 60% or more, and particularly preferably 60% to 75%.

In the present disclosure, the volume fraction of the filler in the layer in contact with the inorganic protective layer is measured by observing a cross section of the layer in contact with the inorganic protective layer with a scanning electron microscope (SEM), and calculating an area ratio occupied by the filler per image. Next, a square root of the area ratio is taken, and a cube of the square root is taken as the volume fraction.

In the method of forming the cross section of the layer in contact with the inorganic protective layer, a sample piece is obtained by cutting the layer in contact with the inorganic protective layer (for example, a charge transport layer) along a thickness direction by a cryomicrotome method.

### Lamination-Type Photosensitive Layer

Examples of the lamination-type photosensitive layer include a laminate in which an undercoat layer, a charge generation layer, and a charge transport layer are laminated, and a laminate in which an undercoat layer, an interlayer, a charge generation layer, and a charge transport layer are laminated.

### Undercoat Layer

The undercoat layer is, for example, a layer containing inorganic particles and a binder resin.

Examples of the inorganic particles include inorganic particles having a powder resistance (volume resistivity) of 10² Ω·cm or more and 10¹¹ Ω·cm or less.

Among the above, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

A volume-average particle diameter of the inorganic particles is, for example, preferably 50 nm or more and 2,000 nm or less (for example, more preferably 60 nm or more and 1,000 nm or less).

A content of the inorganic particles is, for example, preferably 10% by mass or more and 80% by mass or less, and more preferably 40% by mass or more and 80% by mass or less with respect to the binder resin.

The inorganic particles may be subjected to a surface treatment. As the inorganic particles, two or more kinds of inorganic particles subjected to different surface treatments or two or more kinds of inorganic particles having different particle diameters may be used in a form of a mixture.

Examples of a surface treatment agent include a silane coupling agent, a titanate-based coupling agent, an aluminum-based coupling agent, and a surfactant. In particular, for example, a silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane; but the present invention is not limited thereto.

The silane coupling agent may be used in a form of a mixture of two or more kinds thereof. For example, the silane coupling agent having an amino group and other silane coupling agents may be used in combination. Examples of the other silane coupling agents include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; but the present invention is not limited thereto.

A surface treatment method using the surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances, for example, a compound having an anthraquinone structure; a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, or a derivative thereof is preferable.

The electron-accepting compound may be contained in the undercoat layer in a state of being dispersed with the inorganic particles, or in a state of being attached to the surface of the inorganic particles.

Examples of a method of attaching the electron-accepting compound to the surface of the inorganic particles include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while stirring the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing using a stirrer, an ultrasonic disperser, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while stirring and heating the inorganic particles in a solvent and a method of removing the moisture by azeotropically boiling the inorganic particles with a solvent.

The electron-accepting compound may be attached before or after the inorganic particles are subjected to the surface treatment with the surface treatment agent or simultaneously with the surface treatment with the surface treatment agent.

A content of the electron-accepting compound may be, for example, 0.01% by mass or more and 20% by mass or less, preferably 0.01% by mass or more and 10% by mass or less with respect to the inorganic particles.

Examples of the binder resin used for the undercoat layer include a known polymer compound such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoat layer also include a charge-transporting resin having a charge-transporting group, and a conductive resin (for example, polyaniline or the like).

Among the above, as the binder resin used for the undercoat layer, for example, a resin insoluble in a coating solvent of an upper layer is suitable; and a resin obtained by a reaction between at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin, and a curing agent is particularly suitable.

In a case where these binder resins are used in combination of two or more kinds thereof, a mixing proportion thereof is set as necessary.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the undercoat layer as the additive.

Examples of the silane coupling agent as the additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

For example, the undercoat layer has a Vickers hardness of 35 or more.

For example, the surface roughness (ten-point average roughness) of the undercoat layer may be adjusted to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method in the related art is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

A film thickness of the undercoat layer is set to, for example, preferably 15 μm or more and more preferably in a range of 20 μm or more and 50 μm or less.

### Interlayer

An interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method in the related art is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A film thickness of the interlayer is set to, for example, preferably in a range of 0.1 μm or more and 3 μm or less.

The interlayer may be used as the undercoat layer.

### Charge Generation Layer

The charge generation layer is, for example, a layer containing a charge generation material and a binder resin. In addition, the charge generation layer may be a deposition layer of the charge generation material. For example, the deposition layer of the charge generation material is suitable in a case where an incoherent light source such as a light emitting diode (LED) and an organic electro-luminescence (EL) image array is used.

Examples of the charge generation material include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer.

The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 10¹³ Ω·cm or more.

The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method in the related art is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A film thickness of the charge generation layer is set to, for example, preferably in a range of 0.1 μm or more and 5.0 μm or less and more preferably in a range of 0.2 μm or more and 2.0 μm or less.

### Charge Transport Layer

The charge transport layer is a layer containing a binder resin and a charge transport material.

### Charge Transport Material

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

From the viewpoint of charge mobility, for example, a triarylamine derivative represented by Structural Formula (a-1) or a benzidine derivative represented by Structural Formula (a-2) is preferable as the charge transport material.

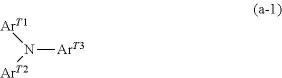

In Structural Formula (a-1), Ar^{T1}, Ar^{T2}, and Ar^{T3} each independently represent a substituted or unsubstituted aryl group, —C₆H₄-C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

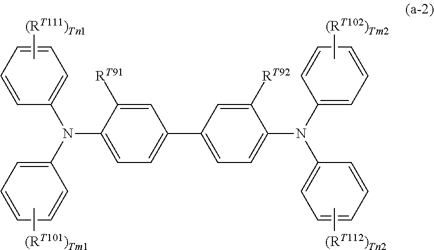

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), in which R^{T12}, R^{T13}, R^{T14}, R^{T15}, and R^{T16} each independently represent a hydrogen atom, a substituted or unsubstituted alkyl group, or a substituted or unsubstituted aryl group. Tₘ₁, Tₘ₂, Tₙ₁, and Tₙ₂ each independently represent an integer of 0 or more and 2 or less.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” or a benzidine derivative having “—CH═CH—CH═C(R^{T15})(R^{T16})” is particularly preferable from the viewpoint of the charge mobility.

The charge transport material may be a polymer.

As the polymer charge transport material, known materials having charge transport properties, such as poly-N-vinylcarbazole and polysilane, are used. In particular, for example, a polyester-based polymer charge transport material is particularly preferable. The polymer charge transport material may be used alone or in combination of the binder resin.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among the above, for example, a polycarbonate resin or a polyarylate resin is preferable as the binder resin. The binder resins may be used alone or in combination of two or more kinds thereof.

A blending ratio between the charge transport material and the binder resin is, for example, preferably 10:1 to 1:5 in terms of mass ratio.

The charge transport layer may also contain other known additives.

The formation of the charge transport layer is not particularly limited, and a known forming method in the related art is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

A film thickness of the charge transport layer is set to, for example, preferably in a range of 5 μm or more and 50 μm or less and more preferably in a range of 10 μm or more and 30 μm or less.

The film thickness of each layer of the photosensitive layer is an arithmetic average of measured values measured with an electromagnetic film thickness meter, and measurement points are four points in a circumferential direction at intervals of 90° in the center of the photoreceptor in the axial direction.

### Conductive Substrate

For example, the electrophotographic photoreceptor according to the present exemplary embodiment preferably has the photosensitive layer on a conductive substrate.

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 10¹³ Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and 15 μm or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Image Forming Apparatus and Process Cartridge

The image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, a transfer device that transfers the toner image to a surface of a recording medium, and a cleaning device that cleans the surface of the electrophotographic photoreceptor by bringing a cleaning member into contact with the surface of the electrophotographic photoreceptor. The above-described electrophotographic photoreceptor according to the present exemplary embodiment is adopted as the electrophotographic photoreceptor.

As the image forming apparatus according to the present exemplary embodiment, a known image forming apparatus such as an apparatus including a fixing device that fixes the toner image transferred to the surface of a recording medium; a direct transfer-type apparatus that transfers the toner image formed on the surface of the electrophotographic photoreceptor directly to the recording medium; an intermediate transfer-type apparatus that primarily transfers the toner image formed on the surface of the electrophotographic photoreceptor to a surface of an intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a discharging device that discharges the surface of the electrophotographic photoreceptor by applying the discharge light after the transfer of the toner image and before the charging; or an apparatus including an electrophotographic photoreceptor heating member for increasing the temperature of the electrophotographic photoreceptor and decreasing the relative temperature is adopted.

In a case of the intermediate transfer-type apparatus, the transfer device has a configuration including an intermediate transfer member with surface on which the toner image will be transferred, a primary transfer device that performs primary transfer to transfer the toner image formed on the surface of the electrophotographic photoreceptor to the surface of the intermediate transfer member, and a secondary transfer device that performs secondary transfer to transfer the toner image transferred to the surface of the intermediate transfer member to the surface of a recording medium.

The image forming apparatus according to the present exemplary embodiment may be any of a dry development-type image forming apparatus or a wet development-type (development type using a liquid developer) image forming apparatus.

In the image forming apparatus according to the present exemplary embodiment, for example, a portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device, in addition to the electrophotographic photoreceptor.

An example of the image forming apparatus according to the present exemplary embodiment will be shown below, but the present invention is not limited thereto. Hereinafter, among the parts shown in the drawing, main parts will be described, and others will not be described.

FIG. 2 is a view schematically showing a configuration of an example of the image forming apparatus according to the present exemplary embodiment.

As shown in FIG. 2, an image forming apparatus 100 according to the present exemplary embodiment includes a process cartridge 300 including an electrophotographic photoreceptor 7, an exposure device 9 (an example of the electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300; the transfer device 40 is disposed at a position that faces the electrophotographic photoreceptor 7 through the intermediate transfer member 50; and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 2 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of a cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 2 shows an example of an image forming apparatus including a fibrous member 132 (roll shape) that supplies a lubricant 14 to the surface of the electrophotographic photoreceptor 7 and a fibrous member 133 (flat brush shape) that assists the cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. In addition, a known charger such as a non-contact type roller charger, and a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. In addition, a surface emission-type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like. Among the above, for example, a developing roller in which a developer is retained on a surface is preferably used.

The developer used in the developing device 11 may be a one-component developer containing only a toner or a two-component developer containing a toner and a carrier. In addition, the developer may be magnetic or non-magnetic. Known developers are employed as the developer.

### Cleaning Device

As the cleaning device 13, a cleaning blade-type device including the cleaning blade 131 is used.

In addition to the cleaning blade-type device, a fur brush cleaning-type device or a simultaneous development cleaning-type device may be adopted.

### Transfer Device

Examples of the transfer device 40 include a known transfer charger such as a contact type transfer charger using a belt, a roller, a film, a rubber blade, or the like, and a scorotron transfer charger or a corotron transfer charger using corona discharge.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. In addition, as the form of the intermediate transfer member, a drum-like intermediate transfer member may be used in addition to the belt-like intermediate transfer member.

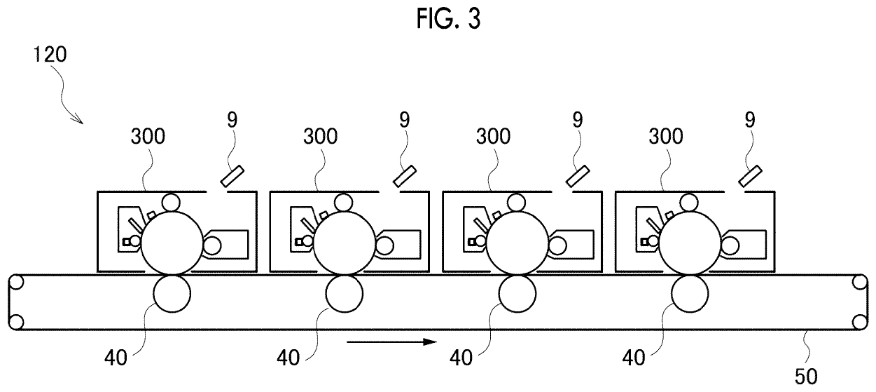

FIG. 3 is a view schematically showing a configuration of another example of the image forming apparatus according to the present exemplary embodiment.

An image forming apparatus 120 shown in FIG. 3 is a tandem type multicolor image forming apparatus in which four process cartridges 300 are mounted. The image forming apparatus 120 is formed such that the four process cartridges 300 are arranged in parallel on the intermediate transfer member 50, and one electrophotographic photoreceptor is used for each color. The image forming apparatus 120 has the same configuration as the image forming apparatus 100, except that the image forming apparatus 120 is of a tandem type.

### EXAMPLES

Hereinafter, exemplary embodiments of the present invention will be specifically described based on Examples. However, the exemplary embodiments of the present invention are not limited to Examples.

In the following description, unless otherwise specified, “parts” and “%” are based on mass.

In the following description, the synthesis, the production, the treatment, the measurement, and the like are carried out at normal temperature (25° C.±3° C.), unless otherwise specified.

### Example 1

### Formation of Undercoat Layer

An aluminum cylindrical tube having an outer diameter of 47 mm, a length of 357 mm, and a thickness of 1 mm is prepared as a conductive substrate.

100 parts of zinc oxide (average particle size: 70 nm, specific surface area: 15 m²/g, manufactured by Tayca Corporation) is stirred and mixed with 500 parts of toluene, 1.3 parts of a silane coupling agent (trade name: KBM603, manufactured by Shin-Etsu Chemical Co., Ltd., N-2-(aminoethyl)-3-aminopropyltrimethoxysilane) is added thereto, and the mixture is stirred for 2 hours. Next, the toluene is distilled off under reduced pressure and baked at 120° C. for 3 hours to obtain zinc oxide subjected to a surface treatment with the silane coupling agent.

110 parts of the surface-treated zinc oxide is stirred and mixed with 500 parts of tetrahydrofuran, a solution obtained by dissolving 0.6 parts of alizarin in 50 parts of tetrahydrofuran is added thereto, and the mixture is stirred at 50° C. for 5 hours. Next, the solid content is separated by filtration by carrying out filtration under reduced pressure, and dried at 60° C. under reduced pressure, thereby obtaining zinc oxide with alizarin.

100 parts of a solution obtained by dissolving 60 parts of the zinc oxide with alizarin, 13.5 parts of a curing agent (blocked isocyanate, trade name: SUMIDUR 3175, manufactured by Sumitomo Bayer Urethane Co., Ltd.), and 15 parts of a butyral resin (trade name: S-LEC BM-1, manufactured by Sekisui Chemical Co., Ltd.) in 68 parts of methyl ethyl ketone is mixed with 5 parts of methyl ethyl ketone, and the mixture is dispersed in a sand mill for 2 hours using glass beads with a diameter of 1 mm, thereby obtaining a dispersion. 0.005 parts of dioctyl tin dilaurate as a catalyst and 4 parts of silicone resin particles (trade name: TOSPEARL 145, manufactured by Momentive Performance Materials Inc.) are added to the dispersion liquid to obtain a coating solution for forming an undercoat layer. The outer peripheral surface of the conductive substrate is coated with the coating solution for forming an undercoat layer by dip coating, and dried and cured at 170° C. for 40 minutes to form an undercoat layer with a layer thickness of 23 μm.

### Formation of Charge Generation Layer

A mixture of 15 parts of hydroxygallium phthalocyanine as a charge generation material (having diffraction peaks at positions where Bragg angles (2θ±0.2°) in the X-ray diffraction spectrum using CuKα characteristic X-rays are at least of 7.5°, 9.9°, 12.5, 16.3°, 18.6°, 25.1°, and 28.3°), 10 parts of a vinyl chloride-vinyl acetate copolymer resin (trade name: VMCH, manufactured by Nippon Unicar Company Limited) as a binder resin, and 200 parts of n-butyl acetate is dispersed in a sand mill for 4 hours using glass beads with a diameter of 1 mm. 175 parts of n-butyl acetate and 180 parts of methyl ethyl ketone are added to the dispersion liquid, and the mixture is stirred to obtain a coating solution for forming a charge generation layer. The undercoat layer is dipped in and coated with the coating solution for forming a charge generation layer, and dried at normal temperature to form a charge generation layer having a layer thickness of 0.25 μm.

### Formation of Charge Transport Layer

Binder resin (polycarbonate resin (1) (viscosity-average molecular weight: 40,000, numerical values in structural formulae indicate molar ratios)): 20 parts
Charge transport material (CTM-1): 15 parts
   Metal oxide particles (silica particles hydrophobized with 1,1,1,3,3,3-hexamethyldisilazane (average particle diameter: 150 nm, average circularity: 0.85, degree of hydrophobicity: 65%)): amount such that volume (%) shown in Table 1 is obtained
Solvent (tetrahydrofuran (THF)): 600 parts

The above-described materials are stirred and mixed for 12 hours to obtain a coating solution for forming a charge transport layer. The charge generation layer is coated with the coating solution for forming a charge transport layer by dip coating under a condition of a room temperature of 28° C. Thereafter, hot air is blown to the coating film to dry the coating film, thereby forming a charge transport layer having a layer thickness of 22 μm.

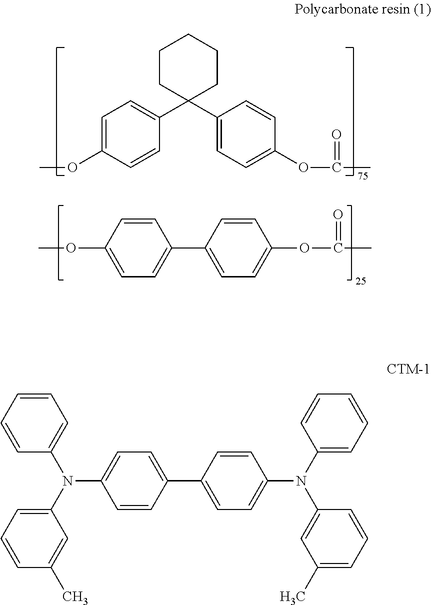

### Surface Polishing of Charge Transport Layer

The surface of the charge transport layer is polished using a diamond paste manufactured by MonotaRO Co., Ltd. An arithmetic mean roughness of the obtained surface of the charge transport layer is shown in Table 1.

### Formation of Inorganic Protective Layer

An amorphous layer containing gallium oxide is formed on the surface of the charge transport layer as an inorganic protective layer by plasma CVD using trimethylgallium as a film forming material. A layer thickness thereof is 3 μm.

A photoreceptor is obtained through the above-described steps.

### Examples 2 to 8 and Comparative Examples 1 and 2

Photoreceptors are produced in the same manner as in Example 1, except that the type, volume fraction, and arithmetic mean particle diameter of the filler, the formulation and layer thickness of the inorganic protective layer, and the arithmetic surface roughness of each layer are changed as shown in Table 1.

### Measurement of Volume Fraction of Filler

Cross-sectional observation of the layer in contact with the inorganic protective layer is carried out with a scanning electron microscope (SEM), and an area ratio occupied by the filler per image is calculated. Next, a square root of the area ratio is taken, and a cube of the square root is taken as the volume fraction.

In the method of forming the cross section of the layer in contact with the inorganic protective layer, a sample piece of the charge transport layer is obtained by cutting the charge transport layer along the thickness direction by a cryomicrotome method.

### Measurement of Arithmetic Mean Particle Diameter of Filler

Cross-sectional observation of the layer in contact with the inorganic protective layer is carried out with a scanning electron microscope (SEM), and an arithmetic mean particle diameter is obtained from particle diameters (circle diameters in the image) of at least 100 or more fillers.

In the method of forming the cross section of the layer in contact with the inorganic protective layer, a sample piece of the charge transport layer is obtained by cutting the charge transport layer along the thickness direction by a cryomicrotome method.

### Measurement of Arithmetic Mean Roughness

The arithmetic mean roughness is measured using a contact-type surface roughness measuring instrument (Surfcom 1400A, manufactured by Tokyo Seimitsu Co., Ltd.).

The measurement conditions are in accordance with JIS B 0601-1994, and the evaluation length Ln is set to 4 mm, the reference length L is set to 0.8 mm, and the cut-off value is set to 0.8 mm.

### Evaluation of Mechanical Strength

A cracking load of the inorganic protective layer is measured as follows to evaluate cracking resistance of the inorganic protective layer.

Measurement by a hardness test using a microhardness tester is repeated while increasing the load from 0 mN to 5 mN increments. By observation with an optical microscope each time the load is applied, a load at which the inorganic protective layer is cracked is defined as a cracking initiation load. The measurement device is as follows.
Test device: product name DUH-201, Shimadzu Corporation
Indenter: diamond spherical indenter

### Evaluation of Cleaning Performance

The cleaning performance is evaluated based on the image quality.

100 sheets of a blank image (image density: 0%), 100 sheets of a 30% halftone image, and then further 100 sheets of a solid image (image density: 100%) are output.

The 100th sheet of the blank image, the 100th sheet of the 30% halftone image, and the 100th sheet of the solid image are visually observed, and the image quality is evaluated according to the following standard.
A: no image quality failure is observed in any of the three types of images.
B: image quality failure (specifically, streak-like image defect) is slightly observed in at least any one of the three types of images, but is within an acceptable range.
C: image quality failure outside the acceptable range occurs in at least any one of the three types of images.

TABLE 1

| | | | | Comparative | | Comparative | |
|---|---|---|---|---|---|---|---|
| | | Example 1 | Example 2 | Example 1 | Example 3 | Example 2 | Example 4 |
| Photosensitive | Type | Lamination- | Lamination- | Lamination- | Lamination- | Lamination- | Lamination- |
| layer | | type | type | type | type | type | type |
| | Kind of filler | Silica | Silica | Silica | Silica | Silica | Silica |
| | Volume fraction of | 55 | 50 | 45 | 55 | 55 | 65 |
| | filler in layer in | | | | | | |
| | contact with | | | | | | |
| | inorganic protective | | | | | | |
| | layer (% by | | | | | | |
| | volume) | | | | | | |
| | Arithmetic mean | 150 | 150 | 150 | 150 | 150 | 150 |
| | particle diameter of | | | | | | |
| | filler (nm) | | | | | | |
| | Arithmetic mean | 0.008 | 0.008 | 0.008 | 0.01 | 0.02 | 0.008 |
| | roughness of | | | | | | |
| | surface (μm) | | | | | | |
| Surface | Formulation | Gallium | Gallium | Gallium | Gallium | Gallium | Gallium |
| protective | | oxide | oxide | oxide | oxide | oxide | oxide |
| layer | Layer thickness | 3 | 3 | 3 | 3 | 3 | 3 |
| | (μm) | | | | | | |
| | Arithmetic mean | 0.008 | 0.008 | 0.008 | 0.01 | 0.02 | 0.008 |
| | roughness of | | | | | | |
| | surface (μm) | | | | | | |
| Evaluation | Cracking initiation | 75 | 70 | 60 | 75 | 75 | 85 |
| result | load (mN) | | | | | | |
| | Cleaning | A | A | A | B | C | A |
| | performance | | | | | | |

| | | Example 5 | Example 6 | Example 7 | Example 8 | Example 9 |
|---|---|---|---|---|---|---|
| Photosensitive | Type | Lamination- | Lamination- | Lamination- | Lamination- | Lamination- |
| layer | | type | type | type | type | type |
| | Kind of filler | Silica | Silica | Silica | Zinc oxide | Silica |
| | Volume fraction of | 55 | 55 | 55 | 55 | 55 |
| | filler in layer in | | | | | |
| | contact with | | | | | |
| | inorganic protective | | | | | |
| | layer (% by | | | | | |
| | volume) | | | | | |
| | Arithmetic mean | 200 | 50 | 80 | 100 | 150 |
| | particle diameter of | | | | | |
| | filler (nm) | | | | | |
| | Arithmetic mean | 0.008 | 0.008 | 0.008 | 0.008 | 0.003 |
| | roughness of | | | | | |
| | surface (μm) | | | | | |
| Surface | Formulation | Gallium | Gallium | Gallium | Gallium | Gallium |
| protective | | oxide | oxide | oxide | oxide | oxide |
| layer | Layer thickness | 3 | 3 | 3 | 3 | 3 |
| | (μm) | | | | | |
| | Arithmetic mean | 0.008 | 0.008 | 0.008 | 0.008 | 0.003 |
| | roughness of | | | | | |
| | surface (μm) | | | | | |
| Evaluation | Cracking initiation | 70 | 70 | 80 | 75 | 75 |
| result | load (mN) | | | | | |
| | Cleaning | A | A | A | A | A |
| | performance | | | | | |

From the above results, it is found that the photoreceptors of Examples are superior in both mechanical strength and cleaning performance as compared with the photoreceptors of Comparative Examples.

(((1))) An electrophotographic photoreceptor comprising:
an inorganic protective layer on a photosensitive layer,
wherein a layer in the photosensitive layer, that is in contact with the inorganic protective layer, contains a filler,
a volume fraction of the filler in the layer in contact with the inorganic protective layer is 50% or more, and
an arithmetic mean roughness of a surface of the inorganic protective layer is 0.01 μm or less.

(((2))) The electrophotographic photoreceptor according to (((1))),
wherein the volume fraction of the filler in the layer in contact with the inorganic protective layer is 55% or more.

(((3))) The electrophotographic photoreceptor according to (((2))),
wherein the volume fraction of the filler in the layer in contact with the inorganic protective layer is 60% or more.

(((4))) The electrophotographic photoreceptor according to any one of (((1))) to (((3))),
wherein the arithmetic mean roughness of the surface of the inorganic protective layer is 0.005 μm or less.

(((5))) The electrophotographic photoreceptor according to any one of (((1))) to (((4))),
wherein the filler is inorganic oxide particles.

(((6))) The electrophotographic photoreceptor according to any one of (((1))) to (((5))),
wherein the filler is silica particles.

(((7))) The electrophotographic photoreceptor according to any one of (((1))) to (((6))),
wherein an arithmetic mean particle diameter of the filler is 50 nm or more and 200 nm or less.

(((8))) The electrophotographic photoreceptor according to (((7))),
wherein the arithmetic mean particle diameter of the filler is 80 nm or more and 150 nm or less.

(((9))) The electrophotographic photoreceptor according to any one of (((1))) to (((8))),
wherein the inorganic protective layer is an oxide of a Group 13 element.

(((10))) A process cartridge comprising:
the electrophotographic photoreceptor according to any one of (((1))) to (((9))),
wherein the process cartridge is attachable to and detachable from an image forming apparatus.

(((11))) An image forming apparatus comprising:
the electrophotographic photoreceptor according to any one of (((1))) to (((9)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image;
a transfer device that transfers the toner image to a surface of a recording medium; and
a cleaning device that cleans the surface of the electrophotographic photoreceptor by bringing a cleaning member into contact with the surface of the electrophotographic photoreceptor.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
an inorganic protective layer on a photosensitive layer,
wherein a layer in the photosensitive layer, that is in contact with the inorganic protective layer, contains a filler,
a volume fraction of the filler in the layer in contact with the inorganic protective layer is 50% or more, and
an arithmetic mean roughness of a surface of the inorganic protective layer is 0.01 μm or less.

2. The electrophotographic photoreceptor according to claim 1,
wherein the volume fraction of the filler in the layer in contact with the inorganic protective layer is 55% or more.

3. The electrophotographic photoreceptor according to claim 2,
wherein the volume fraction of the filler in the layer in contact with the inorganic protective layer is 60% or more.

4. The electrophotographic photoreceptor according to claim 1,
wherein the arithmetic mean roughness of the surface of the inorganic protective layer is 0.005 μm or less.

5. The electrophotographic photoreceptor according to claim 1,
wherein the filler is inorganic oxide particles.

6. The electrophotographic photoreceptor according to claim 1,
wherein the filler is silica particles.

7. The electrophotographic photoreceptor according to claim 1,
wherein an arithmetic mean particle diameter of the filler is 50 nm or more and 200 nm or less.

8. The electrophotographic photoreceptor according to claim 7,
wherein the arithmetic mean particle diameter of the filler is 80 nm or more and 150 nm or less.

9. The electrophotographic photoreceptor according to claim 1,
wherein the inorganic protective layer is an oxide of a Group 13 element.

10. A process cartridge comprising:
the electrophotographic photoreceptor according to claim 1,
wherein the process cartridge is attachable to and detachable from an image forming apparatus.

11. A process cartridge comprising:
the electrophotographic photoreceptor according to claim 2,
wherein the process cartridge is attachable to and detachable from an image forming apparatus.

12. A process cartridge comprising:
the electrophotographic photoreceptor according to claim 3,
wherein the process cartridge is attachable to and detachable from an image forming apparatus.

13. A process cartridge comprising:
the electrophotographic photoreceptor according to claim 4,
wherein the process cartridge is attachable to and detachable from an image forming apparatus.

14. A process cartridge comprising:
the electrophotographic photoreceptor according to claim 5,
wherein the process cartridge is attachable to and detachable from an image forming apparatus.

15. A process cartridge comprising:
the electrophotographic photoreceptor according to claim 6,
wherein the process cartridge is attachable to and detachable from an image forming apparatus.

16. A process cartridge comprising:
the electrophotographic photoreceptor according to claim 7,
wherein the process cartridge is attachable to and detachable from an image forming apparatus.

17. A process cartridge comprising:
the electrophotographic photoreceptor according to claim 8,
wherein the process cartridge is attachable to and detachable from an image forming apparatus.

18. A process cartridge comprising:
the electrophotographic photoreceptor according to claim 9,
wherein the process cartridge is attachable to and detachable from an image forming apparatus.

19. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image;
a transfer device that transfers the toner image to a surface of a recording medium; and
a cleaning device that cleans the surface of the electrophotographic photoreceptor by bringing a cleaning member into contact with the surface of the electrophotographic photoreceptor.

20. An image forming apparatus comprising:
the electrophotographic photoreceptor according to claim 2;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image;
a transfer device that transfers the toner image to a surface of a recording medium; and
a cleaning device that cleans the surface of the electrophotographic photoreceptor by bringing a cleaning member into contact with the surface of the electrophotographic photoreceptor.
